(19) United States
(12) Patent Application Publication
(10) Pub. No.: US 2005/0031530 A1
(43) Pub. Date: Feb. 10, 2005

(54) Method and apparatus for producing a peroxyacid solution

(76) Inventor: Perry L. Martin, Yuba City, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/878,176

(22) Filed: Jun. 28, 2004

Related U.S. Application Data
(60) Provisional application No. 60/494,009, filed on Aug. 7, 2003.

(51) Int. Cl. C01B 15/06

(52) U.S. Cl. 423/513; 422/198; 422/105; 422/224

(57) ABSTRACT

A method and apparatus for production of a high-concentration H₂SO₅ solution is presented. This high-concentration H₂SO₅ solution is useful for producing a stable, non-hygroscopic triple salt. The invention includes a single-stage reactor that includes a reservoir for holding an oxyacid solution and an inlet to the reservoir for receiving a peroxide solution. The peroxide solution is added such that a gradient of peroxide concentration forms in the oxyacid solution as a function of distance from the inlet, and less than all of the oxyacid solution reacts with the peroxide solution at a given time. A stirring mechanism slowly dissipates the gradient, so that any H₂SO₅ formed as a result of reaction between the peroxide and the oxyacid is stirred away from the high-peroxide concentration zone, thereby preventing the decomposition of H₂SO₅ by an equilibrium reaction. The temperature of the reservoir is maintained at less than or equal to 20 ° C.

### RELATED APPLICATION

This application claims the benefit of U.S. Provisional Application Ser. No. 60/494,009 filed on Aug. 7, 2003 under 35 U.S.C. §119(e) and incorporates the content of the provisional application by reference in its entirety.

### FIELD OF INVENTION

This invention relates generally to a process and apparatus for generating peroxyacid solutions and particularly to a process and apparatus for generating a Caro's acid solution.

### BACKGROUND

Potassium monopersulfate (KHSO₅), also known as potassium peroxymonosulfate, is a component of a triple salt with the formula 2KHSO₅—KHSO₄—K₂SO₄. Due to the high oxidation potential of potassium monopersulfate (“PMPS”), the PMPS triple salt 2KHSO₅—KHSO₄—K₂SO₄ makes a good candidate as a component in bleaches, cleansing agents, detergents, and etching agents, and also as an oxidizing agent in inorganic reactions.

While PMPS's strong oxidation potential is well known, PMPS is limited in its utility because of the presence of an irritating byproduct, K₂S₂O₈. The severe irritating qualities of K₂S₂O₈ and its inherent stability relative to the desirable KHSO₅ limit the use of PMPS to products that would not come in contact with its users. Thus, while PMPS could be used in personal care products, manufacturers do not use PMPS for the fear that users of these products will experience irritation from the K₂S₂O₈. The irritating effects of K₂S₂O₈ even limit the use of PMPS in products that come into contact with users (and their pets) indirectly, such as surface cleaners, laundry bleaching agents, and swimming pool water treatment solutions. Even low levels of K₂S₂O₈ accumulated in pool water or laundry as residues can cause undesirable effects on humans and pets that come into contact with it. Ideally, to be able to use PMPS in these products, the level of K₂S₂O₈ K₂S₂O₈ as a byproduct should be <0.1 wt. % of the PMPS.

One way to reduce or eliminate the fraction of K₂S₂O₈ in a PMPS product is to increase the yield and stability of the desirable KHSO₅ without using oleum, since the use of oleum results in the production of K₂S₂O₈. Since a higher active oxygen content in the end product correlates with a higher fraction of KHSO₅, it is desirable to achieve a PMPS composition with increased active oxygen content and higher stability using H₂SO₄. Publicly available Caro's acid conversion data (e.g., data from FMC Corporation) indicates that with H₂SO₄ to H₂O₂ molar ratios of 1:1 and 2:1, the active oxygen obtained from the Caro's acid equilibrium products yields 4.3% and 3.7%, respectively.

Typically, PMPS triple salt is produced by using Caro's acid (H₂SO₅, also called peroxymonosulphuric acid). Caro's acid is usually produced by reacting H₂SO₄ or oleum with H₂O₂. More specifically, Caro's acid is an equilibrium product between these reactants on one hand and H₂SO₅ and H₂O on the other, as shown by the following reaction:
H₂SO₄+H₂O₂<<>>H₂SO₅ (Caro's acid)+H₂O.
As the molar ratio of H₂SO₄ to H₂O₂ increases, the yield of H₂SO₅ increases. Thus, in order to optimize the amount of Caro's acid that is produced, excess H₂SO₄ or oleum is added during the process.

The Caro's acid is reacted with alkali potassium salts such as KHCO₃, K₂CO₃, and/or KOH to generate KHSO₅:
H₂SO₅+KOH→KHSO₅+H₂O.
Thus, increasing the yield of Caro's acid results in a higher concentration of KHSO₅, which helps reduce formation of the irritant K₂S₂O₈. The potassium to sulfur ratio (K/S) is controlled to produce a specific composition. Generally, a K/S of <1.0 will result in a high yield of KHSO₅ because K/S>1.0 induces some attrition of the desired salt to produce K₂SO₄.

However, the salt resulting from K/S<1.0 is too unstable for most commercial applications and is hygroscopic. To make a stable, non-hygroscopic triple salt, a sufficient level of K/S must be achieved to produce the stabilizing sulfate salts (i.e., KHSO₄ and K₂SO₄). In producing these compositions, the excess potassium (K/S>1.0) reacts with both KHSO₅ and KHSO₄, following an attrition close to their molar ratios. The decomposition of monopersulfate reduces the A.O. level in the resulting triple salt and increases sulfates.

Various parameters have been manipulated to optimize Caro's acid production. One of these parameters is reaction temperature. Temperature has been controlled to reduce the decomposition of Caro's acid, which results in release of oxygen and increase in sulfate salts, neither of which is desirable. Some knowledge regarding preparation of Caro's acid and PMPS triple salt are provided in the following references:
U.S. Pat. No. 3,939,072 (“the '072 Patent) teaches a process for point of use production of Caro's acid, in which the Caro's acid is cooled to between −10° C. to 80° C. to reduce decomposition of the Caro's acid before its use.
U.S. Pat. No. 5,141,731 (“the '731 Patent”) teaches a process and an apparatus for point of use generation of peroxyacids by adding H₂O₂ to a stream of H₂SO₄ in multiple stages. The H₂SO₄ is cooled to between 15 to −40° C. before this addition. After the addition, the resulting solution is cooled to a temperature of 0 to 80° C. to reduce the decomposition of Caro's acid. The Caro's acid has to be diluted with water or used immediately thereafter, before decomposition of the Caro's acid happens. As in the '072 Patent, the cool temperature is maintained to prevent A.O. loss that is generally caused by a higher temperature resulting from the exothermic reaction. The solution is reported to be 15% higher in H₂SO₅ when using multiple additions of H₂O₂ versus one addition. In lab experiments, Caro's acid solution is produced over a period of about 20 seconds, diluted with water to a solution strength of less than 200 g/l to stop the reactions, then chilled to preserve the Caro's acid for analysis. In practical use, the invention requires a series of stages wherein some amount of H₂O₂ is added to the oxyacid in each stage, mixed, and cooled.

This method illustrates that a higher percentage of H₂O₂ conversion can be achieved by controlling the order of addition of the reagents. However, the resulting Caro's acid solution must be used immediately after production as is the case utilizing the disclosed invention, or rapidly diluted with water in order to preserve the benefits of the invention. If not used or diluted immediately after its production, as disclosed in literature and prior art, the KHSO₅ portion of the Caro's acid solution will decompose to achieve the equilibrium product that is well established in the prior art, resulting in a triple salt having an A.O. of ≦4.3.

Another shortcoming of this method is that it is difficult to implement with the use of traditional single-stage reactors. This technique requires multiple series of reactors, each independent of the other, to provide a single pass process. Naturally, this process excludes the use of traditional single-stage reactors such as batch or stirred tank reactors that take a substantially longer time to complete the H₂O₂ addition.

U.S. Pat. No. 5,429,812 (“the '812 Patent”), which discloses a process of producing peroxysulfuric acid from substoichiometric levels of H₂SO₄ to H₂O₂, teaches using a substoichiometric amount of H₂SO₄ to produce an equilibrium amount of Caro's acid. The final mixture in the '812 Patent has a molar ratio of SO₃ to Available Oxygen in the range of 0.8 to 0.2. According to the '812 Patent, the order in which these reagents are introduced does not affect the Caro's acid yield. The reagents used were 70% H₂O₂ and 93% H₂SO₄. The '812 Patent discloses that regardless of taking steps to avoid decomposition such as cooling and agitation, equilibrium occurred very quickly when the reactants were brought into contact, and that the position of the equilibrium depended consistently on the molar concentrations of the reactants, independently of the order of introduction.

As disclosed in the '812 Patent, even with adequate cooling and agitation to prevent decomposition, the equilibrium proceeds rapidly and results with an A.O. value consistent with the established equilibrium products. This occurred regardless of the order of reactant addition and was independent of the reactant concentrations, which include H₂O concentration. Also, previously, it was known that using 70% H₂O₂ and H₂SO₄ will result in a Caro's acid solution with an active oxygen content of no greater than 4.3% at a 1:1 molar ratio.
U.S. Pat. No. 5,139,763 (“the '763 Patent”) teaches making Caro's acid with a supra-stoichiometric molar amounts of oleum to H₂O₂ It discourages using H₂SO₄ on the grounds that a higher molar equivalent of H₂SO₄ is required to obtain similar yields of H₂SO₅ compared to oleum, resulting in a higher manufacturing cost. Also, when this high molar equivalent of H₂SO₄ is used, the molar ratio of the resultant solution has a H₂SO₅ to H₂SO₄ ratio that is less than what is desired for the preparation of the PMPS triple salt. The Caro's acid is partially neutralized to raise the K/S to 1.15-1.25, then combined with a solution richer in monopersulfate.

The method of the '763 Patent involves many steps and results in an undesirably high concentration of K₂S₂O₈.
U.S. Pat. No. 5,607,656 (“the '656 Patent”) describes a process for producing PMPS with high available oxygen and a low concentration of K₂S₂O₈. This process involves reacting 20 to 70 wt. % strength oleum with 30 to 70 wt. % strength hydrogen peroxide to form Caro's acid, partially neutralizing the Caro's acid, then adding sulfuric acid and potassium hydroxide to the mixture by injection into the vacuum crystallizer while evaporating off the moisture. The resulting wet salt has a K₂S₂O₈ concentration of less than 1.5 wt. %, which is reported to be less than that found in the commercially available triple salt. However, the commercial advantage of this process is limited by the increase in cost associated with all the additional reagents (higher SO₄ to H₂O₂ molar ratio) required to dilute the K₂S₂O₈ concentration in the triple salt, and the resulting A.O. as compared to the initial Caro's acid solution.

The '656 Patent discloses a process for producing a triple salt with reduced oxodisulfate by reacting Caro's acid produced from oleum with additional H₂SO₄ and KOH. This dilution process utilizes established processing techniques as previously disclosed. Like other disclosures, the critical chemistry and control parameters are met to produce the resulting triple salt.
U.S. Pat. No. 4,579,725 (“the '725 Patent”) describes a process for producing PMPS with high available oxygen and low K₂S₂O₈ by partially neutralizing the Caro's acid produced from 65-75% oleum and H₂O₂ by reacting the reagents at a sulfur to peroxide molar ratio of 0.9 to 1.2. The Caro's acid is reacted with KOH to achieve a K/S ratio <0.95. The resulting slurry is concentrated by using vacuum evaporation so that the fraction of the slurry solids is sustained at <40%. The mother liquor that is rich in KHSO₅ is recycled back to the evaporator. MgCO₃ is aggressively added to the concentrated slurry to control the K/S ratio to yield a product of high A.O. The MgCO₃ treatment is needed because the product has low-K/S product has low stability and melting point.

The '725 Patent uses 65-75% oleum to produce Caro's acid, performs partial neutralization with KOH solution to achieve K/S ratio <0.95, concentrates using vacuum evaporation to slurry solids of <40%, forms a wet cake while returning concentrate back to the evaporator, adds MgCO₃ to the cake, mixes and dries, and adds more MgCO₃.

The resulting monopersulfate salt from the low K/S ratio is hygroscopic and unstable. Coating with MgCO₃ was shown to stabilize the salt. MgCO₃ has been used as an anti-caking agent to improve fluidity of the triple salt for many years.
U.S. Pat. No. 4,610,865 (“the '865 Patent”) discloses a process to produce and concentrate a solution containing KHSO₅ to a monopersulfate concentration of 20-30 wt. % KHSO₅, cooling a partial stream to <15 C. to precipitate the triple salt, filtering the triple salt, and drying.

Like the '725 Patent, the '865 Patent defines specific chemical and control parameters to produce a composition of triple salt precipitated from a solution of KHSO₅ using a cold precipitation technique. The equipment and methods of producing the Caro's acid, triple salt, concentrating and separating are consistent with previously disclosed methods of processing. The resulting monopersulfate, like that in the '725 Patent, is produced from substoichiometric levels (excess sulfuric acid) of potassium to sulfur, and therefore is hygroscopic and exhibits poor shelf life.

The currently available methods of producing a stable, non-hygroscopic (K/S>1.15) triple salt of reduced K₂S₂O₈ with high active oxygen (>4.7%) require additional treatment of the slurry streams, reprocessing of solutions of triple salt to dilute the K₂S₂O₈, and/or other additional treatment steps to increase stability and melting point of the resulting triple salt. In doing so, waste streams of discarded inert salts such as K₂SO₄ is produced, and the process increases in its complexity with more steps, higher recycle rates, and elaborate process control measures. The increased complexity of production process usually increases the production cost, thereby adversely affecting the commercial viability of the PMPS triple salt. A simpler and more cost-efficient method of producing the PMPS triple salt is desired.

### SUMMARY

The invention provides a method and apparatus for producing the PMPS triple salt in a more cost-efficient manner than the conventional methods. The invention may be used to produce a stable, non-hygroscopic triple salt with less K₂S₂O₈ and higher active oxygen content than currently available processes of comparable cost.

In one aspect, the invention is a single-stage reactor for producing a high yield of peroxyacid that includes a reservoir for holding an oxyacid solution, an inlet to the reservoir for receiving a peroxide solution, and a heat exchange mechanism for maintaining the oxyacid solution at a temperature less than or equal to 20° C. The inlet is located such that a gradient of peroxide concentration forms in the oxyacid solution as a function of distance from the inlet upon addition of the peroxide solution. Less than all of the oxyacid solution reacts with the peroxide solution at a given time.

In another aspect, the invention is a method of producing a peroxyacid solution in a single reaction stage by providing a reservoir containing an oxyacid solution and adding a peroxide solution to the reservoir through an inlet. The peroxide solution has to be added slowly, to form a gradient of peroxide concentration as a function of distance from the inlet in the oxyacid solution. After a desired level of reaction is achieved between the oxyacid and the peroxide, the solution is removed from the reservoir through an outlet.

In yet another aspect, the invention is a method of producing a rich Caro's acid solution in a single reaction stage. The method entails providing a reservoir having a cylindrically-shaped sidewall, adding a peroxide solution to the reservoir through a primary inlet, and adding an oxyacid solution to the reservoir through a secondary inlet. The peroxide solution and the oxyacid solution are added to the reservoir such that a gradient of peroxide concentration as a function of distances from the primary and the secondary inlets is formed, and only a portion of the oxyacid solution reacts with the peroxide at a given time. After the desired level of reaction is achieved, the solution is removed from the reservoir through an outlet.

### BRIEF DESCRIPTION OF THE DRAWINGS

FIG. 1 is a schematic illustration of a process for generating potassium monopersulfate compositions.

FIG. 2 is a ternary diagram illustrating the compositions of triple salts (EGXYE and EGQRE) produced in accordance with different embodiments of the invention.

FIG. 3 is a batch reactor process that may be used to produce the triple salt in accordance with the invention.

FIG. 4 is a continuous multi-pass process that may be used to produce the potassium monopersulfate compositions in accordance with the invention.

FIG. 5 is a continuous single-pass process that may be used to produce the potassium monopersulfate compositions in accordance with the invention.

FIG. 6 is a thin film, continuous single-stage reactor that may be used to produce the potassium monopersulfate compositions in accordance with the invention.

FIG. 7 is a flowchart illustrating a first method of producing PMPS triple salt with low K₂S₂O₈ and high A.O.

FIG. 8 is a flowchart illustrating a second method of producing PMPS triple salt with low K₂S₂O₈ and high A.O.

FIG. 9 is a flowchart illustrating a third method of producing PMPS triple salt with low K₂S₂O₈ and high A.O.

FIG. 10 is a schematic illustration of a monitoring system for the reactor of the invention.

### DETAILED DESCRIPTION OF THE PREFERRED EMBODIMENT(S)

Embodiments of the invention are described herein in the context of a swimming pool, and particularly in the context of disinfecting the swimming pool water. However, it is to be understood that the embodiments provided herein are just preferred embodiments, and the scope of the invention is not limited to the applications or the embodiments disclosed herein. For example, although Caro's acid is used as an example of a peroxyacid solution, production of other peroxyacid solutions may benefit from the invention as well.

As used herein, a “high yield” refers to a yield that is higher than what is achieved based on the established equilibrium for a given molar ratio of reactants. For example, for Caro's acid, a “high yield” would indicate a higher concentration of H₂SO₅ in the solution that results from a reaction between a given ratio of H₂SO₄ and H₂O₂ than what would be expected at equilibrium. As used herein, a “peroxide solution” refers to a solution of H₂O₂ and water. An “oxyacid solution” refers to either a solution containing H₂SO₄ and/or SO₃. “Oleum” refers to free SO₃ dissolved in H₂SO₄. A “Caro's acid solution” refers to Caro's acid (H₂SO₅) mixed with one or more of H₂O₂, H₂O, and H₂SO₄. The terms “stabilizing” and “stabilized,” when used in reference to the Caro's acid solution, indicate the suppression of the equilibrium reaction, or suppression of Reaction 1b (see below) that converts the H₂SO₅ back to the reactants. A “stable” potassium monopersulfate composition, on the other hand, has an active oxygen loss of <1% per month. “Non-hygroscopic” means having a K:S ratio greater than 1.

A “peroxyacid” is an acid containing the bivalent group O—O, including but not limited to peroxycarboxylic acids such as peracetic acid, which is an equilibrium product of acetic acid and peroxide, and Caro's acid. A “weak” Caro's acid is Caro's acid with sub-stoichiometric molar ratio of H₂SO₄ to H₂O₂. A “rich” Caro's acid solution is a solution with an SO₄ molar ratio of greater than or equal to the H₂O₂ based on the reactants basis.

As used herein, “radial” indicates a circular or elliptical pattern.

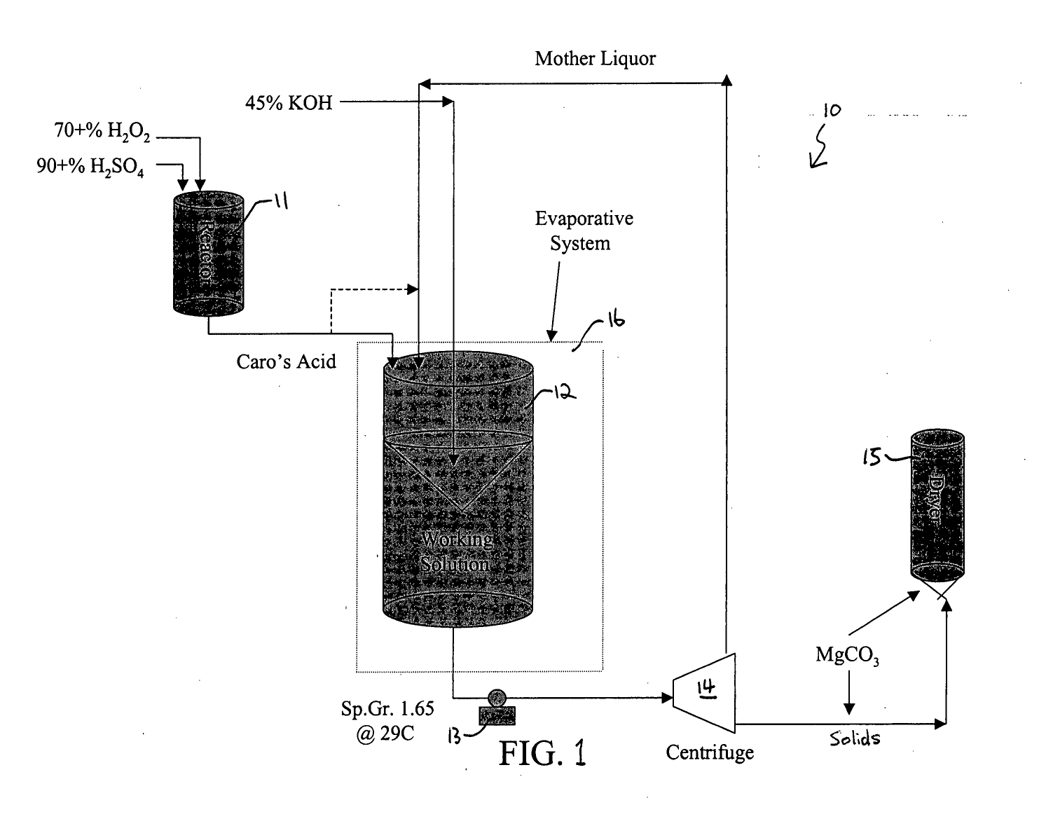

FIG. 1 is a continuous single-pass process system 10 that may be used to implement the invention. The single-pass process system 10 includes a reactor 11 where the sulfur source solution (e.g., H₂SO₄, oleum) and the peroxide solution are reacted to generate Caro's acid. In addition, the system 10 includes a working tank 12, a slurry pump 13, a centrifuge 14, and a dryer 15. The Caro's acid generated in the reactor 11 is combined with an alkali potassium salt in the working tank 12 to generate the PMPS triple salt, which is in the form of a slurry. The slurry containing the triple salt is pumped by the slurry pump 13 into the centrifuge 14, which separates the slurry into solids and mother liquor. The slurry contains at least 30 wt. % solids, as determined by the specific gravity of the slurry being greater than 1.55 at 29° The mother liquor is recycled back into the working tank 12. The mixture of the recycled mother liquor, the Caro's acid, the alkali potassium salt, and the slurry in the working tank 12 is herein referred to as the “working solution.” The working solution is concentrated by being mixed in a vacuum evaporator 16 at a temperature less than or equal to 35° C.

The rate of the reaction between H₂SO₅ and H₂O changes with temperature and with the order of reagent addition. Thus, by controlling the temperature and the order in which reagents are introduced to produce Caro's acid, a Caro's acid solution having an H₂SO₅ concentration that is substantially higher than that of currently available Caro's acid solutions can be produced. Furthermore, by shifting the reaction rate by manipulating temperature, the Caro's acid with high H₂SO₅ concentration can be stabilized. The stabilized Caro's acid solution may be used for various purposes, one of which is the production of the PMPS triple salt. The PMPS triple salt prepared with the high- H₂SO₅ Caro's acid solution has an A.O. level that is substantially higher than that of conventional PMPS triple salts.

In one aspect, the invention pertains to the reactor 11. The reactor 11 can be designed based on the discovery that the Caro's acid equilibrium reaction is affected by both the temperature and the order of reagent introduction. If the reactants are added in the right order under the right temperature to favor the formation of H₂SO₅, and if the resulting product is stabilized until all the reactants are added and the reaction is complete, Caro's acid production is optimized for high H₂SO₅ concentration. High H₂SO₅ concentration translates into decreased waste product and reduces the production cost. Furthermore, a high concentration of H₂SO₅ results in a higher concentration of KHSO₅, and a Caro's acid solution having a higher molar ratio of KHSO₅/H₂SO₄ can be used to prepare a stable, non-hygroscopic PMPS triple salt composition that has an active oxygen greater than the reported maximum of 4.3% (e.g., the '731 Patent). To prepare a useful version of the high-A.O. PMPS triple salt, the increased concentration of H₂SO₅ has to be stabilized, and the reactor of the invention allows H₂SO₅ to be stabilized.

As stated above, Caro's acid is an equilibrium product of the following two equilibrium reactions:
H₂SO₄+H₂O₂→H₂SO₅+H₂O (Reaction 1a)
H₂SO₅+H₂O→H₂SO₄+H₂O₂ (Reaction 1b)
Reaction 1a is herein referred to as the “forward reaction,” and Reaction 1b is herein referred to as the “reverse reaction.” H₂SO₄+H₂O₂ are herein referred to as the “reactants.” As the water content increases, the rate of forward reaction decreases. Also, as the concentrations of the reactants become reduced due to the forward reaction, the rate of the forward reaction decreases.

Initially, when H₂O₂ is added to a solution of H₂SO₄, the molar ratio of H₂SO₄ is many times higher than the H₂O₂ and the rate of conversion in the forward reaction is high. When the temperature is kept to below or at 20° C., the rate of the reverse reaction (Reaction 1b) is suppressed, maintaining a high concentration of H₂SO₅. However, as the addition of H₂O₂ continues, the molar ratios of H₂O₂ and H₂SO₄ become closer to 1.0, the concentration of H₂O increases, and the rate of the forward reaction is reduced. Thus, while the initial rate of reactants' conversion to H₂SO₅ is higher than that achieved if H₂SO₄ were to be added to H₂O₂ or if both reactants were combined at once, the benefits of controlling the order of addition are lost with time due to the effects of the reverse reaction (this was illustrated in the '812 Patent). The reverse reaction ultimately lowers the active oxygen level in the PMPS triple salt that is produced with the resulting Caro's acid solution. Thus, measures are needed to stabilize the high- H₂SO₅ solution and suppress the reverse reaction.

The '072 Patent and the '731 Patent suggest stabilizing the high- H₂SO₅ solution by using or diluting the Caro's acid solution immediately after production, before the effect of the reverse reaction becomes significant. However, because the reverse reaction quickly begins to take place, it is difficult to complete the dilution process before the reverse reaction takes place, at least with the typical batch and stirred tank reactors. Whereas maintaining the temperature at or below 80° C. is sufficient to reduce the decomposition of the Caro's acid before its application in point-of-use applications, this temperature control method is impractical when the reactant addition and dilution are done in a single stage. For example, a batch reactor, a stirred tank reactor, or a thin-film reactor, which are frequently used for single-stage reactions, require considerable time for reactant additions and completion of the reactions that the reverse reaction would have already been triggered by the time the reagent addition is complete. Without means of stabilizing the H₂SO₅ portion of the Caro's acid, the equilibrium is rapidly achieved (as disclosed in '812). The equilibrium occurs despite the efforts of cooling the temperature adequately to reduce the decomposition of H₂SO₅.

The reactor of the invention achieves the high- H₂SO₅ level in a Caro's acid solution by allowing the reactants to mix a portion at a time. More specifically, the reactor is designed such that a peroxide concentration gradient forms in an oxyacid solution, as a function of distance from the inlet through which the peroxide solution is introduced. Due to the concentration gradient, only a portion of the oxyacid solution reacts with the peroxide at a given time. There is a stirring mechanism in the reactor that allows a controlled dissipation of this concentration gradient. The effect of the stirring is that after the peroxide and the oxyacid react to form H₂SO₅ in an area of high peroxide concentration, the H₂SO₅ is stirred away from the area where the reaction occurred, preventing the reverse process from being triggered and allowing more H₂SO₅ to form as more peroxide solution is introduced. Since the reverse reaction becomes significant only after the gradient dissipates (i.e., cannot stir the H₂SO₅ away to an area free of H₂O₂), the Caro's acid solution is moved to the next stage, e.g., the working tank 12 in FIG. 1, when the gradient dissipates.

Oleum, which is rich in SO₃, may be added to the H₂O₂ to convert water present in the peroxide solution since reducing the water concentration helps drive the forward reaction. Oleum also consumes some of the water that is released from the peroxide during the forward reaction. The reaction of oleum and water proceeds as follows:
H₂O+SO₃>>>H₂SO₄ (Reaction 2)
As the molar ratio of oleum to H₂O₂ approaches 1.0, the ratio of free H₂O to SO₃ is significantly reduced, and SO₃ begins reacting directly with H₂O₂ as illustrated by the following formula:
2 SO₃+H₂O₂>>>H₂S₂O₈ (Reaction 3)
The production of H²S²O⁸ is undesirable, as it may ultimately result in the formation of the irritant K₂S₂O₈.

In order to achieve high active oxygen, sufficient oleum is added to convert as much of the H₂O₂ as is economically permitted. As discussed in many of the prior art patents, the molar ratio of sulfur from oleum to peroxide is generally 1.1 to 1.6, with 1.18 being frequently recited.

As illustrated in the '725 Patent, in order to prevent or eliminate K₂S₂O₈, elaborate process control to balance the slurry chemistry between recycled mother liquor and neutralized Caro's acid solutions are required. Also, other methods are proposed involving reprocessing triple salt solution by treatment with alkali potassium salts to precipitate and remove unwanted K₂SO₄, thereby enriching the KHSO₅ content, or adding additional H₂SO₄ with KOH to the triple salt solution as in the '656 Patent, thereby diluting the K₂S₂O₈.

In order to produce a stable, non-hygroscopic triple salt composition high in A.O. with substantially no K₂S₂O₈, several criteria must be met. First, it is desirable to stabilize H₂SO₅ immediately after its formation, to prevent reversion back to the reactants H₂SO₄ and H₂O₂ according to the reverse reaction of Reaction 1b. Second, residual (free) H₂O must be minimized to maximize the yield in H₂SO₅. This can be accomplished by using reactants in the highest range of activity as possible.

Where oleum is used in any of the reaction steps, the feed-rate of oleum, and molar ratio of oleum to H₂O₂ must be controlled within specific guidelines to prevent formation of H²S²O⁸ by the reaction of Equation 3 above.

The invention includes novel methods of producing a highly stable, nonhygroscopic potassium monopersulfate composition with high active oxygen and substantially no detectable K₂S₂O₈. Thus far, the prevalent belief was that the order of reactant introduction does not affect the reaction outcome when potassium monopersulfate is made with a supra-stoichiometric to stoichiometric molar ratio of H₂SO₄ to H₂O₂. Once a method of stabilizing the H₂SO₅ has been developed, various unique methods of processing Caro's acid and its resulting triple salt can be used to produce compositions of high available oxygen with substantially reduced K₂S₂O₈.

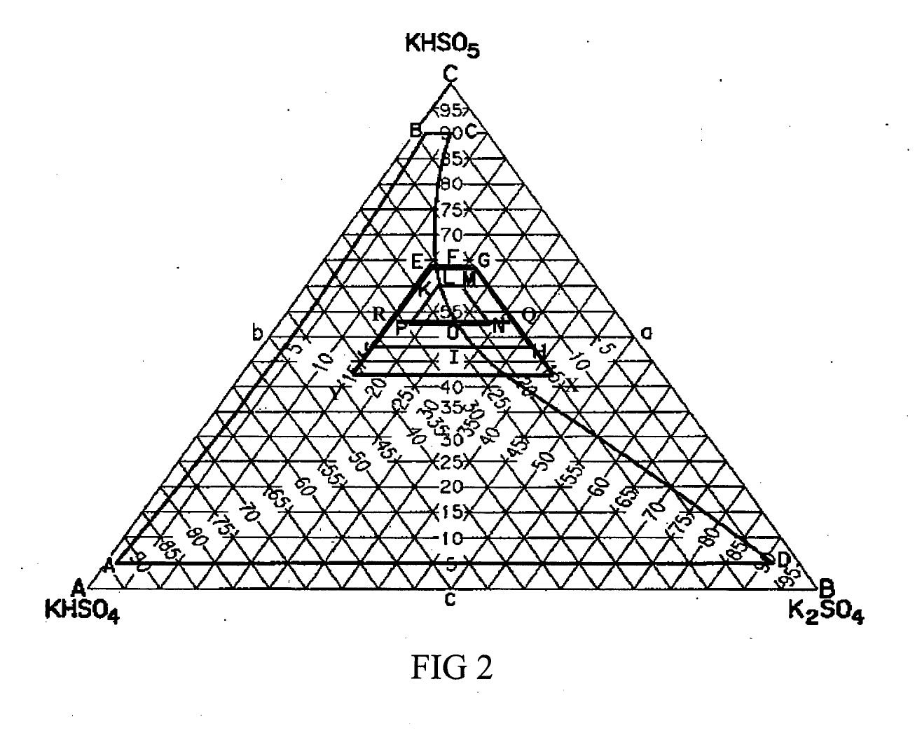

FIG. 2 is a ternary diagram illustrating the compositions of triple salts produced using the method of the invention, as will be described in more detail below.

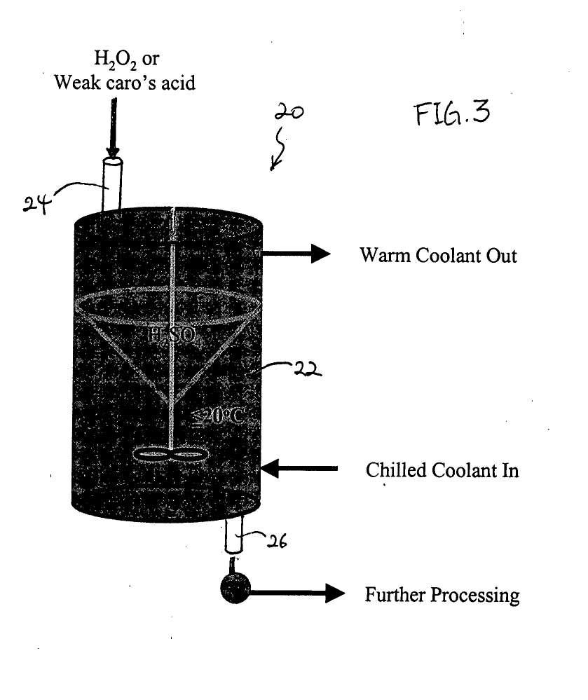

FIG. 3 is a single-stage batch reactor 20 that may be used to implement the invention. The batch reactor 20 has a reservoir 22 and an inlet 24 and an outlet 26 to the reservoir 22. The inlet 24 and the outlet 26 are preferably far apart from each other. Although the reservoir 22 is shown to be cylindrically shaped, it may be of any shape that can hold a fluid. There is a stirring mechanism 28 for creating convection in the fluid inside the reactor 20. The stirring mechanism 28 preferably creates a convective motion radially, so that the solution flows parallel to the inner walls of the cylindrical reservoir 22. In addition, a heat exchange mechanism is used to control the temperature of the fluid in the reservoir 22. The heat exchanger may be of the well-known shell-and-tube configuration whereby a chilled coolant flows along the outer surface of the reservoir 22. Where heat is given off by an exothermic reaction in the reservoir 22, the coolant will be warmed when it exits the shell surrounding the reservoir 22.

In one embodiment, an oxyacid (e.g., sulfuric acid) solution is added to the reservoir 22 and stirred. Then, a peroxide solution is added to the oxyacid solution through the inlet 24 slowly enough for a peroxide concentration gradient to form in the reservoir. When the peroxide solution is first added, there is initially a higher concentration of peroxide (H₂O₂) near the inlet 24 and the concentration gradually decreases with distance from the inlet 24, forming a gradient of peroxide concentration. Since the ratio of oxyacid to peroxide is high initially, only a portion of the oxyacid solution is treated by the peroxide solution. The oxyacid near the inlet (where the concentration of H₂O₂ is high) reacts with the peroxide to produce H₂SO₅, which then gets stirred away from the inlet. By stirring the H₂SO₅ away from the inlet with the stirring mechanism 28, the concentration of H₂SO₅ near the inlet is kept at a low level, preventing the reverse reaction from being triggered. With continued stirring, the gradient dissipates in about 0.1 to 60 minutes, depending on various factors such as the concentrations of the solutions, the stirring speed, and the size of the reservoir 22.

The oxyacid solution may be a sulfuric acid solution of about 93-100% H₂SO₄ by weight. Alternatively, the oxyacid solution may be a Caro's acid solution. The peroxide solution may be a mixture of H₂O₂ and water, with the weight fraction of H₂O₂ being 70-99.6%. Alternatively, the peroxide solution may be a weak Caro's acid solution having a sub-stoichiometric ratio of H₂SO₄ to H₂O₂.

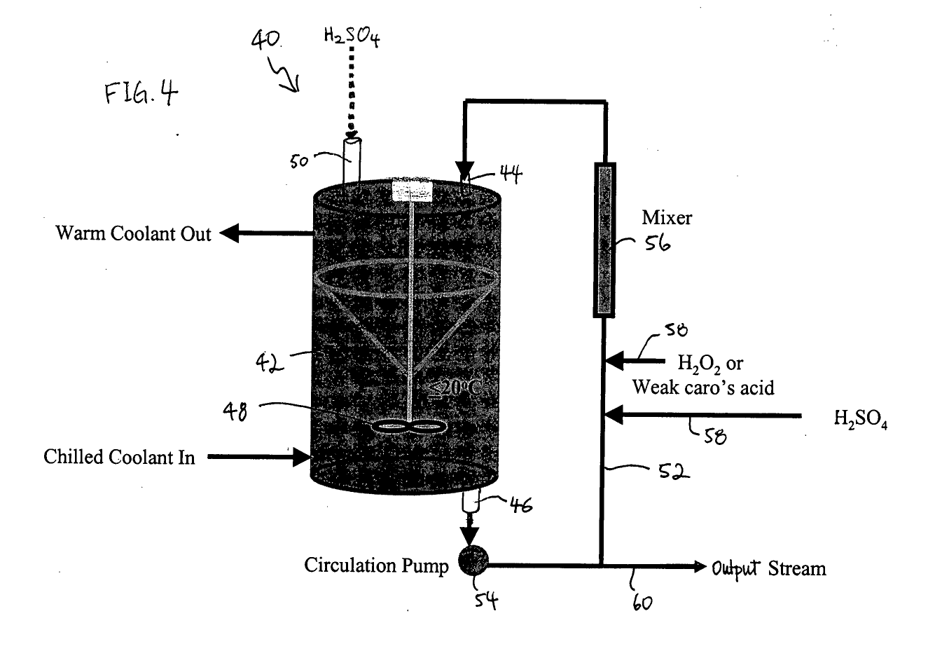

FIG. 4 is a continuous multi-pass reactor 40 that includes a reservoir 42 and an inlet 44 and an outlet 46 to the reservoir 42. There is a stirring mechanism 48 and a heat exchange mechanism whereby a chilled coolant is placed in contact with the reservoir 42, perhaps in a shell-and-tube configuration.

Unlike the batch reactor 20 of FIG. 3, the continuous multi-pass reactor 40 includes a circulation path 52 for recycling some of the solution that flows out of the reservoir 42 back to the reservoir 42. The circulation path 52 connects the outlet 46 to the inlet 44. Using the circulation path 52, solution that flows out of the reservoir 42 through the outlet 46 is pumped by a circulation pump 54 into a mixer 56 and then back into the reservoir 42 via the inlet 44. Along the circulation path 52, there are one or more input streams 58 for adding reagents to the circulation path 52. The input streams 58 are positioned to add the reagents to the circulation path 52 before the circulated fluids reach the mixer 56 so that the reagents will be pre-mixed before flowing into the reservoir 42.

To prevent accumulation of fluids in the reservoir 42, an output stream 60 is set aside from the circulation path 52 and forwarded to the next process stage instead of being recycled back to the reservoir 42. To keep a substantially constant fluid volume in the reservoir 42, the flow rate of the output stream 60 is similar to the combined flowrate of the input streams 58. A “circulation stream” refers to the fluid that flows through the circulation path 52 and exits through the inlet 44. The flow rate of the circulation stream is approximately equal to the flow rate at the outlet 46 minus the flow rate of the output stream 60, plus the flow rate of the input streams 58. In some embodiments, the continuous multi-pass reactor 40 has another, or secondary, inlet 50 that may be used for initially placing the oxyacid solution in the reservoir 42.

In one embodiment, the reactor 40 includes a cylindrical sidewall with two circular faces on each end, as shown in FIG. 4. The inlet 44 and the outlet 46 are located on different circular faces. Where there is the secondary inlet 50, the two inlets 44, 50 are located on the same circular face. What is shown in FIG. 4 is just an exemplary embodiment of the reactor 40, and other shapes and configurations of the reactor 40 are within the scope of the invention.

Since the outlet 46 is positioned far away from the inlet 44 and the circulation inlet 50, the fluid that exits the reservoir 42 contains Caro's acid solution and any residual H₂SO₄. A part of it is siphoned off in the output stream 60, and a peroxide solution and/or more oxyacid solution is added through the input streams 58. The recycled stream is mixed with the reagents in the input stream 58 in the mixer 56, where they react at least partially. More mixing and reacting occurs after the fluids enter the reservoir 42. The fluids that enter the reservoir 42 through the circulation inlet 50 include one or more of Caro's acid, H₂SO₄, H₂O₂, and H₂O. Since any H₂O₂ added to the reservoir 42 is added through the circulation inlet 50, there forms a gradient of H₂O₂ concentration as a function of distance from the circulation inlet 50. As in the batch reactor 20 of FIG. 3, any H₂SO₅ formed as a result of H₂O₂ reacting with H₂SO₄ is stirred away from the circulation inlet 50, preventing the reverse reaction from being triggered. The output stream 60 has a high concentration of H₂SO₅ that may be used for making triple salt with high A.O. content.

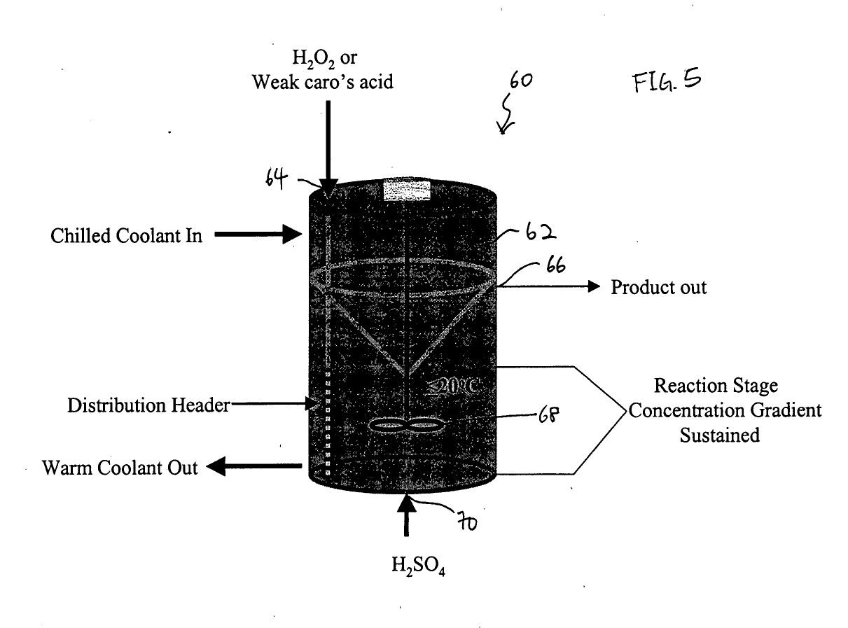

FIG. 5 is a continuous single-pass reactor 60 that may be used to implement the invention. The reactor 60 includes a reservoir 62, a primary inlet 64, an outlet 66, and a stirring mechanism 68 much like the reactor 40 described above. The reservoir 62 is preferably cylindrically shaped. In addition to the primary inlet 64, the reactor 60 has a secondary inlet 70 located far away from the primary inlet 64. The outlet 66 is located between the primary inlet 64 and the secondary inlet 66. A cooling mechanism whereby a chilled coolant is placed in contact with the reservoir 62 is used to maintain the reservoir 62 at a desired temperature.

The peroxide solution is added to the primary inlet 64, and the oxyacid solution is added to the secondary inlet 70. There is a gradient of peroxide concentration formed as a function of distance from the inlet 64. The peroxide concentration is highest near the primary inlet 64 and lowest near the secondary inlet 70, where the reaction with H₂SO₄ consumes most of the peroxide in the area. The stirring mechanism 68 stirs H₂SO₅ away from the secondary inlet 70, making room for more H₂O₂ to fill and react with the H₂SO₄. Preferably, the outlet 66 is located to pull the solutions with the highest H₂SO₅ content.

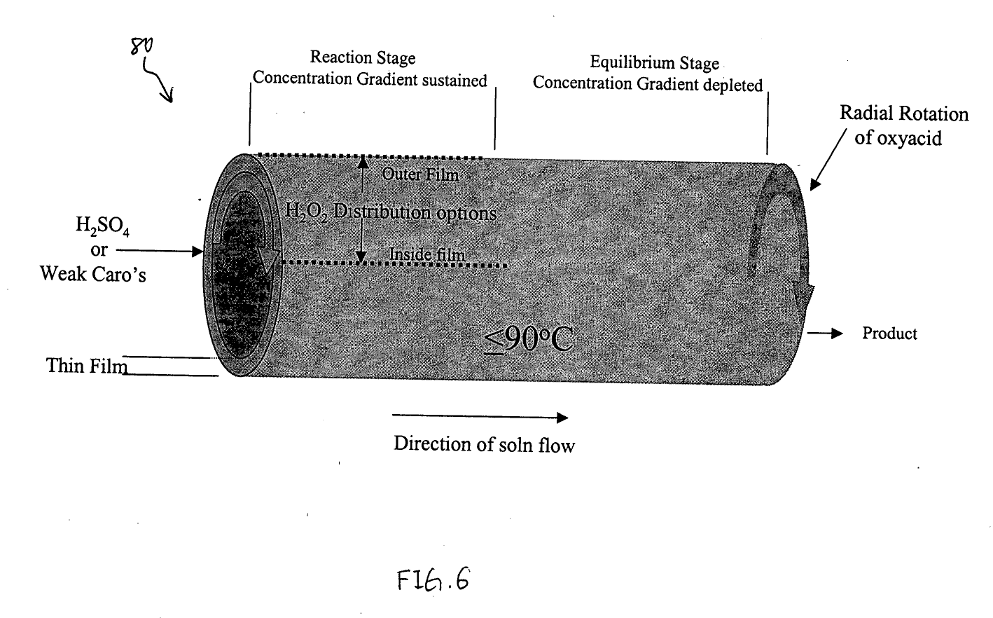

FIG. 6 is a continuous horizontal thin film reactor 80 that may be used to implement the invention. The horizontal thin film reactor 80 circulates the H₂SO₄ radially under high shear, thereby forming a thin film of solution along the internal wall of the reactor. With continuous flow of H₂SO₄, the solution moves laterally down the wall of the reactor. Optional baffles may be included to enhance flow and mixing. The peroxide or the weak Caro's acid may be applied by distribution from an atomizing spray or distribution header aligned in a lateral direction to the wall of the reactor. The distributor can be arranged either as perforations in the wall of the reactor, in contact with the circulating solution, or supported along the inside of the reactor whereby the circulating solution is between the distribution header and the wall of the reactor. More descriptions of the thin film reactor 80 are provided in U.S. Provisional Application Ser. No. 60/494,009.

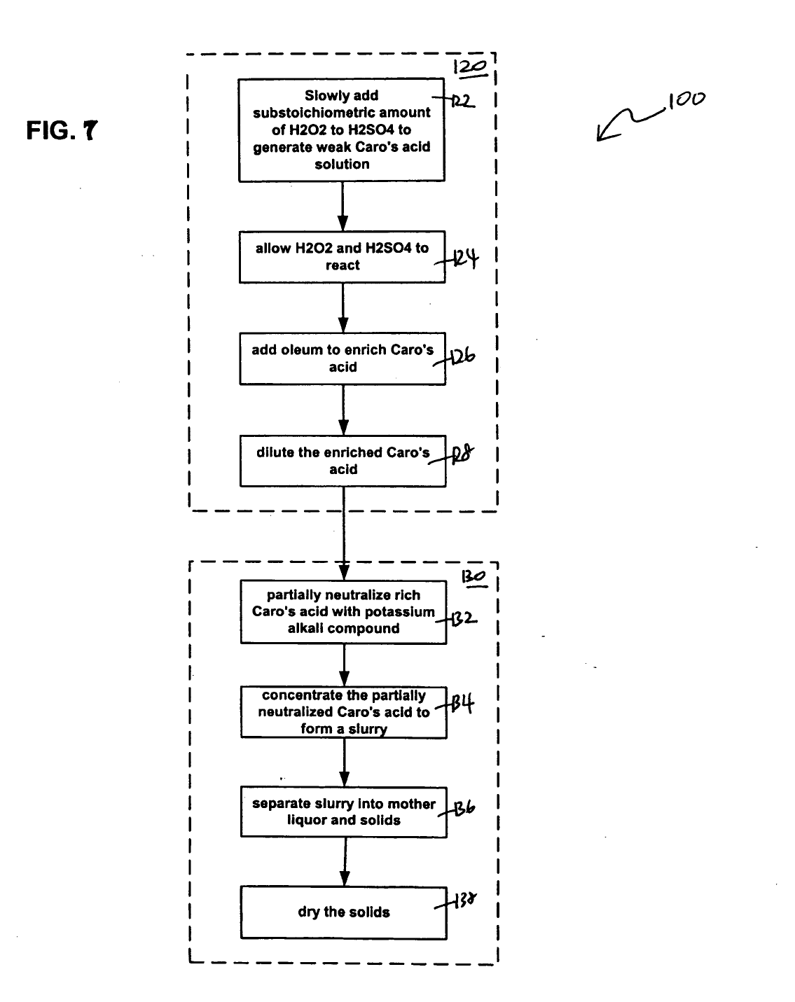

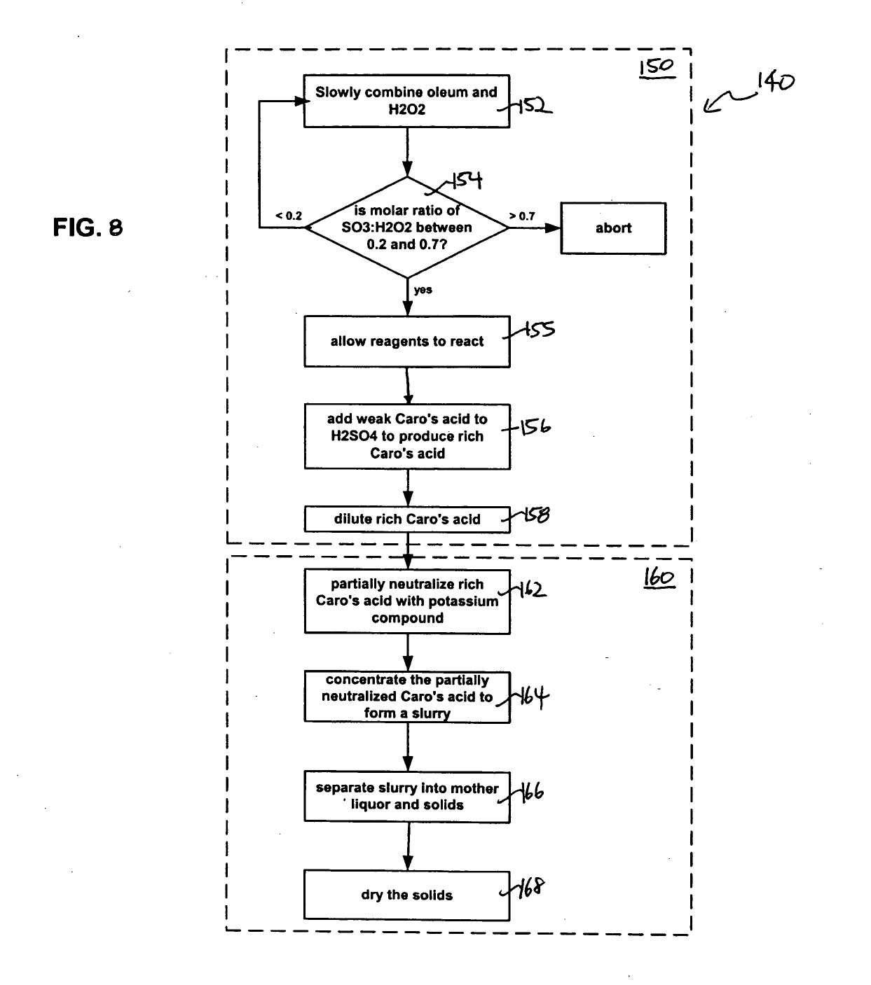

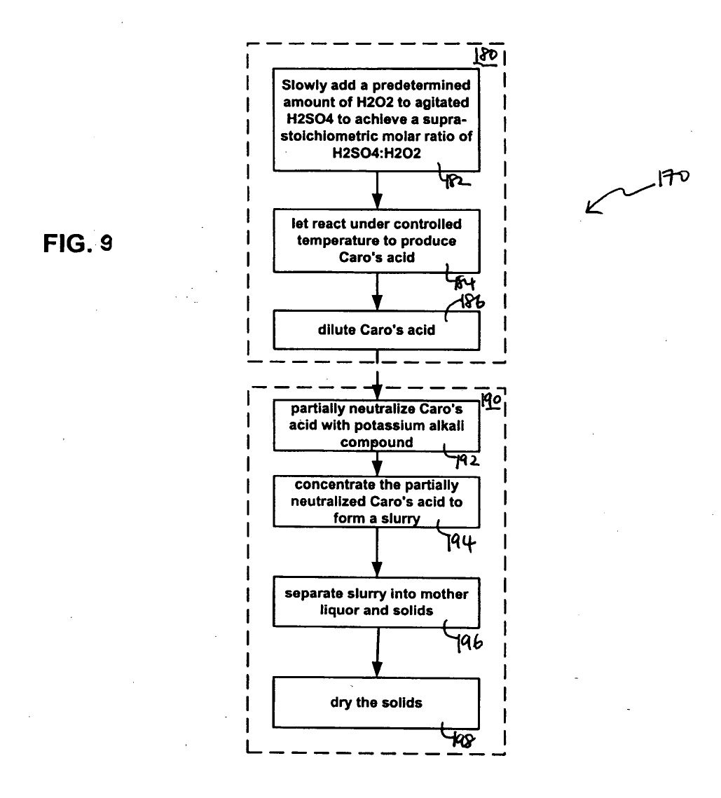

The reactors of FIG. 3, FIG. 4, FIG. 5, and FIG. 6 may be used to produce a rich Caro's acid in a number of different ways, some of which are illustrated in FIG. 7, FIG. 8, and FIG. 9. FIG. 7 illustrates a way of producing the rich Caro's acid solution by adding H₂O₂ to H₂SO₄ at a substoichiometric ratio of H₂SO₄:H₂O₂ followed by addition of oleum. FIG. 8 illustrates a way of producing the rich Caro's acid solution by reacting oleum and H₂O₂ at a SO₃:H₂O₂ ratio in the range of about 0.2˜0.7, followed by addition of the resultant Caro's acid to H₂SO₄. FIG. 9 illustrates producing the rich Caro's acid solution by adding H₂O₂ to H₂SO₄ at supra-stoichiometric ratio of H₂SO₄:H₂O₂. The rich Caro's acid solution is diluted with water while controlling the resulting mixture's temperature at <18° C., preferably <10° C. The resulting mixture is then partially neutralized with a solution of alkali potassium salt to raise the K/S ratio of between 1.10 to 1.25. The optimum K/S ratio is dependent on which method is used to produce the Caro's acid.

Method #1

The Caro's acid composition resulting from controlling the order of reactant addition (i.e., H₂O₂ to H₂SO₄) and thereby obtaining a supra-stoichiometric to stoichiometric ratio of H₂SO₄ to H₂O₂, results in a higher active oxygen content from H₂SO₅. The resulting Caro's acid solution can be stabilized to maintain a high H₂SO₅ concentration. By reducing the reverse reaction between H₂SO₅ and H₂O, a Caro's acid solution is produced which, upon partial neutralization with an alkali potassium, produces a PMPS triple salt having a K/S ratio of between 1.15 to 1.25. Such PMPS triple salt has an active oxygen higher than that of PMPS triple salt made with conventional methods, and does not suffer from the drawbacks of K₂S₂O₈ formation.

Upon slow continuous or incremental addition of H₂O₂ and/or Caro's acid solution to H₂SO₄ under a temperature at or below 20° C., the rate of the forward reaction is initially high due to the excess H₂SO₄ and low H₂O concentration. With continued addition of H₂O₂, the H₂SO₅ converts back to H₂SO₄. However, the controlled temperature suppresses the rate of conversion of H₂SO₅ even as the H₂O concentration increases. The reversion rate is sufficiently reduced to allow for the benefits provided by the order of reactant addition to be utilized in the production of a triple salt composition. The resulting triple salt is substantially higher in A.O. than the conventional triple salt.

FIG. 7 is a flowchart of a first stabilized triple salt production process 100 in accordance with the invention. The first stabilized triple salt production process 100 includes a first Caro's acid production process 120 and a conversion and separation process 130. In the first Caro's acid production process 120, an H₂O₂ solution is slowly (e.g., incrementally) added to an H₂SO₄ solution, maintaining a substoichiometric ratio of H₂SO₄:H₂O₂ (step 122). Preferably, the H₂O₂ solution has a H₂O₂ concentration >70%. This slow addition increases the conversion of H₂O₂ to H₂SO₅ and increases the release of bound H₂O from the H₂O₂. As a result, there is more free H₂O in the solution. The resulting weak Caro's acid still contains residual H₂O₂ and free H₂O, which lead to a higher active oxygen content. The amount of residual H₂O₂ is minimized by stopping its addition as soon as the stoichiometric molar ratio of H₂SO₄:H₂O₂ is reached or exceeded. The H₂O₂ and the H₂SO₄ are allowed to react for at least 0.1 hour (step 124).

Then, oleum is added (step 126) to the weak (i.e., sub-stoichiometric molar ratio of total H₂SO₄ to H₂O₂) Caro's acid solution, which still contains residual H₂O₂ and free H₂O, to raise the molar ratio of SO₄ to H₂O₂ to at least the stoichiometric level. Upon the addition of oleum, the free H₂O reacts with SO₃, per Reaction 2. By minimizing residual H₂O₂, formation of H²S²O⁸ per Reaction 3 is minimized. After step 126, a rich Caro's acid is produced. The rich Caro's acid is optionally diluted (step 128). Temperature is maintained at a level <20 C. throughout the process 20 to stabilize the H₂SO₅.

The rich Caro's acid is subjected to the process 130 to form a PMPS triple salt with high A.O. and a substantially reduced amount of K₂S₂O₈ compared to the conventional triple salts. The diluted Caro's acid solution is partially neutralized with an alkali potassium compound (step 132) to achieve a K/S ratio greater than 1, preferably between 1.10 to 1.25. The partially neutralized solution is concentrated to form a slurry (step 134), for example by mixing in a vacuum evaporator. The slurry is then separated into mother liquor and solids (step 136), wherein the solids contain the desired PMPS composition. The solids are dried (step 138), preferably at a temperature <90 C. and more preferably at a temperature <70° C., to obtain a PMPS composition that does not have much H₂O. The resulting PMPS composition has an active oxygen content higher than 4.3 and has substantially no irritant (K₂S₂O₈).

1. First Example of Method #1

28.54 g of 70% H₂O₂ (approx. 0.59 mol H₂O₂) was added drop-wise to 60.02 g of vigorously agitated 93% H₂SO₄ (approx. 0.57 mol H₂SO₄) while controlling the temperature with an ice/brine solution between 5-8° C. The addition took 2.5 hrs and produced a Caro's acid solution from almost a 1:1 molar ratio of H₂SO₄ to H₂O₂.

The Caro's acid solution was allowed to react with vigorous agitation for 60 minutes while the temperature was controlled between 2−° C.

The Caro's acid solution was diluted with 47.5 g deionized H₂O by addition of the Caro's acid to the water with vigorous agitation while controlling the temperature between 10-15 C.

48.78 g K₂CO₃ was diluted with 66.98 g deionized H₂O. This solution was added drop-wise to the vortex of the vigorously agitated solution of diluted caro's acid to raise the K/S ratio to 1.2. Temperature was varied between 11-17° C. Total lapsed time to complete the addition was 18 minutes.

The solution was transferred to a glass evaporation tray and placed on a hot plate. A fan was used to increase air circulation and reduce the pressure above the solution. The temperature was controlled between 28-30 C. while continuous mixing was applied.

After 1.75 hrs, the solution was concentrated to a thick paste. The paste was spread across the tray and the temperature was increased to induce drying. The triple salt was periodically mixed and crushed to increase the efficiency of drying. The resulting triple salt had an A.O. content of 4.82% and 0.0% K₂S₂O₈.

This Example illustrates that a triple salt composition having an increase in A.O. of 12% greater than that expected from the anticipated equilibrium products from a 1:1 molar ratio of 96% H₂SO₄ to 70% H₂O₂ by use of the invention. Also, it has been demonstrated that by utilizing the disclosed invention, 80% of the increased H₂SO₅ proposed in '731 is stabilized and recovered in the form of KHSO₅. These results clearly demonstrate that the rate of the equilibrium reaction can be suppressed to benefit from the supra-stoichiometric ratio induced by the order of reactant addition for the formation of a triple salt composition.

2. Second Example of Method #1

20.54 g of 76% H₂O₂ (approx. 0.46 mol H₂O₂) was slowly added to 10.02 g 98% H₂SO₄ (approx. 0.1 mol H₂SO₄).

46.67 g of 26% oleum was slowly added through a drip tube to the weak Caro's acid over a period of 1.5 hours.

The temperature was maintained at between −2 to 8 C. during both steps of the Caro's acid production.

The rich The rich Caro's acid solution was added to 47.23 g deionized H₂O while controlling the temperature between 0-6° C.

48.89 g K₂CO₃ was diluted with 59.95 g of deionized H₂O and slowly added to the vortex of the rich Caro's acid, K/S 1.18.

The solution was concentrated using evaporation techniques described in the previous examples to a thick paste. 1.02 g magnesium carbonate hydroxide pentahydrate was added, then the solids were dried.

The resulting triple salt was 6.3% A.O. and 0.0% K₂S₂O₈.

This Example illustrates that H₂O bound in the H₂O₂ can be effectively released by utilizing the steps of the invention, then reacted with SO₃ in the oleum to produce a triple salt free of K₂S₂O₈.

3. Third Example of Method #1

Add a supra-stoichiometric ratio of 70-99.6% H₂O₂ to agitated 90-100% H₂SO₄ while controlling the temperature at ≦20° C., and preferably ≦15° C., and more preferably ≦10° C. The resulting weak Caro's acid solution is converted to a rich Caro's acid solution by slowly or incrementally adding to a solution of 1-75% oleum while controlling the temperature at ≦20° C., preferably ≦15° C., and more preferably ≦10° C. to produce a rich Caro's acid solution.

The partially neutralized triple salt resulting from the use of the resulting Caro's acid is further processed to produce a nonhygroscopic triple salt defined by the enclosed curve EGXYE, and more specifically EGHJE in FIG. 2 with <0.1 wt % K₂S₂O₈, and having the general formula: (KHSO₅)x.(KHSO₄)y.(K₂SO₄)z, where x+y+z=1 and x=0.53-0.64, y=0.15-0.33, and z=0.15-0.33.

Method #2

FIG. 8 is a flowchart of a second stabilized triple salt production process 140 in accordance with the invention. The second stabilized triple salt production process 140 includes a second Caro's acid production process 150 and a conversion and separation process 160. In the second Caro's acid production process 140, oleum is reacted with H₂O₂ at a substoichiometric molar ratio of oleum:H₂O₂ (step 152). In contrast to Method #1, the order of reagent introduction is not as important in Method #2, and either reagent may be added to the other. The addition of the reagent stops when the molar ratio of SO₃ to H₂O₂ is between about 0.2 and about 0.7 (step 154). If this molar ratio range is accidentally passed, it is preferably to start the process over again. By maintaining the SO₃:H₂O₂ molar ratio within the range of about 0.2˜0.7, inclusive, the concentration of H²S²O⁸ is maintained at a low level. Once all the reagents are combined, let the reagents react for at least 0.1 hour (step 155).

The free H₂O is partially consumed by the SO₃, per Reaction 2. The resulting weak Caro's acid, which contains residual H₂O₂, is slowly added to the H₂SO₄ to further benefit from the higher conversion offered by controlling the order of addition of reagents (step 156). By using substoichiometric ratios of oleum: H₂O₂ to consume H₂O, and then applying the resulting Caro's acid solution to H₂SO₄, a rich Caro's acid solution is produced. The partially neutralized Caro's acid solution is diluted, if needed (step 158).

The diluted Caro's acid solution is subjected to the PMPS composition formation process 160. The diluted Caro's acid solution is first partially neutralized by addition of a potassium alkali compound (step 162) to achieve a K/S ratio greater than 1. The partially neutralized solution is concentrated to form a slurry (step 164), for example by mixing in a vacuum evaporator. The slurry is then separated into mother liquor and solids (step 166), wherein the solids contain the desired PMPS composition. The solids are dried (step 168), preferably at a temperature <90 C. and more preferably at a temperature <70° C., to obtain a PMPS composition that does not have much H₂O. The resulting PMPS composition has an active oxygen content higher than 4.3 and has substantially no irritant (K₂S₂O₈).

1. First Example of Method #2

50.14 g of 20% oleum was slowly added through a drip tube to 22.35 g of 76% H₂O₂ over a period of 2.5 hours with vigorous mixing. The weak Caro's acid was allowed to react for 30 minutes. The weak Caro's acid solution was then slowly added to 10.06 g of 98% H₂SO₄ while controlling the temperature between 0-8° C. The rich Caro's acid solution was allowed to react for 45 minutes.

The rich Caro's acid solution was added to 47.81 g of deionized H₂O while controlling the temperature to between 6-9° C. 50.37 g of K₂CO₃ was dissolved in 61.75 g of deionized H₂O and slowly added drop-wise to the vortex of the diluted Caro's acid while controlling the temperature between 15-20° C., K/S 1.15.

The solution was evaporated using the techniques described in the previous examples to produce a thick past. The sample (approximately 90 g) was treated with 1 g of magnesium carbonate hydroxide pentahydrate and dried. The resulting treated triple salt had an A.O. of 6.46% and 0.0% K₂S₂O₈.

This Example illustrates that a commercially available 20% oleum can be reacted substoichiometric with peroxide to produce a weak Caro's acid substantially free of H²S²O⁸. The weak Caro's acid is then reacted with H₂SO₄ inducing a supra-stoichiometric ratio of SO₄ to H₂O₂, resulting in a rich Caro's acid solution, which is then processed to produce a triple salt having high A.O. and no measurable K₂S₂O₈.

2. Second Example of Method #2

A substoichiometric ratio of 1-75% oleum is added to an agitated solution of 70-90% H₂O₂ while controlling the temperature at ≦25° C., preferably at ≦15° C., and more preferably at ≦10° C. The resulting weak Caro's acid solution is slowly or incrementally added to a solution of agitated H₂SO₄ while controlling the temperature at ≦20° C., preferably ≦15° C., and more preferably ≦10° C. to produce a rich Caro's acid solution.

The partially neutralized triple salt resulting from the use of Caro's acid produced according to Method #2 is further processed to produce a nonhygroscopic triple salt defined by the enclosed curve EGXYE, and more specifically EGHJE in FIG. 2 with <0.1 wt % K₂S₂O₈, and having the general formula: (KHSO₅)x.(KHSO₄)y.(K₂SO₄)z, where x+y+z=1 and x=0.53-0.64, y=0.15-0.33, and z=0.15-0.33.

Method #3

FIG. 9 is a third triple salt production process 170, which includes a third Caro's acid production process 180 and a conversion and separation process 180. Slowly (continuously or incrementally) add H₂O₂ to an agitated H₂SO₄ solution to induce a supra-stoichiometric molar ratio of H₂SO₄ to H₂O₂ (step 182). As more H₂O₂ is added, the molar ratio of H₂SO₄/H₂O₂ decreases. Stop adding H₂O₂ when the final ratio is stoichiometric or substoichiometric. Then, let the reagents react for at least 0.1 hour (step 184) to form Caro's acid before diluting the Caro's acid (step 186). The dilution may be with water or a mother liquor recycled from the process 190.

The diluted Caro's acid is partially neutralized with a potassium alkali compound (step 192) to achieve a K/S ratio greater than 1, preferably between 1.10 to 1.25. The partially neutralized solution is concentrated to form a slurry (step 194), for example by mixing in a vacuum evaporator. The slurry is then separated into mother liquor and solids (step 196), wherein the solids contain the desired PMPS composition. The solids are dried (step 198), preferably at a temperature <90 C. and more preferably at a temperature <70° C., to obtain a PMPS composition that does not have much H₂O. The resulting PMPS composition has an active oxygen content higher than 4.3 and has substantially no irritant (K₂S₂O₈).

1. First Example of Method #3

22.03 g of 76% H₂O₂ (approx. 0.49 mol of H₂O₂) was added drop-wise to 60.02 g of vigorously agitated 98% H₂SO₄ solution (approx. 0.6 mol of H₂SO₄) while controlling the temperature with an ice/brine solution between 5-13° C. The addition took 0.5 hrs.

The Caro's acid solution was allowed to react with vigorous agitation for 1.25 hrs while the temperature was controlled between 2-5 C in an ice/brine solution.

The Caro's acid solution was diluted with 47.17 g deionized H₂O by addition of the Caro's acid to the water with vigorous agitation while controlling the temperature between 10-12° C.

47.78 g K₂CO₃ was diluted with 66.16 g of deionized H₂O. This solution was added drop-wise to the vigorously agitated solution of diluted Caro's acid to raise the K/S ratio to 1.20. The temperature was varied between 10-15° C. The resulting solution was separated into Sample 1 and Sample 2.

Sample 1 was transferred to a glass evaporation tray and placed on a hot plate. A fan was used to increase air circulation and reduce the pressure above the solution. The temperature was controlled between 28-30° C. while continuous mixing was applied. The solution was concentrated to a thick paste. The paste was spread across the tray and the temperature was increased to induce drying. The triple salt was periodically mixed and crushed to increase the efficiency of drying. The resulting triple salt had an A.O. content of 5.35% and 0.0% K₂S₂O₈.

This Example illustrates that utilizing point of use concentration of hydrogen peroxide to raise the peroxide to >70%, approximately a 1:1 molar ratio as in example 1 that employs the methods of the disclosed invention results in a triple salt having substantially increased A.O. without any detectable levels of K₂S₂O₈.

2. Second Example of Method #3

Sample 2 was concentrated using the evaporation techniques used in Sample 1 until a heavy precipitate formed. The specific gravity was determined to be 1.87, which correlated to a slurry solids content of 65 wt. %. The resulting slurry was filtered and dried. The resulting triple salt had an A.O. of 5.38 and 0.0% of K₂S₂O₈.

This Example illustrates that a slurry concentrated to a desired specific gravity, separated and dried, can be effectively used to produce a product of higher A.O. without K₂S₂O₈.

3. Third Example of Method #3

The H₂O₂ solution has an active content of 70-99.6 wt. % and the H₂SO₄ solution has an active content of 90-100 wt. %. During the addition of the H₂O₂ solution, the solution is maintained at a temperature ≦20° C., and preferably ≦15° C., and more preferably <10° C. The Caro's acid solution is mixed for about 0.01-1 hours thereafter before dilution. These process steps can take place under vacuum, or at or above atmospheric pressure.

The partially neutralized triple salt resulting from the use of Caro's acid thus produced is further processed to produce a nonhygroscopic triple salt defined by the enclosed curve JHXYJ in FIG. 2 with <0.1 wt % K₂S₂O₈, and having the general formula: (KHSO₅)x.(KHSO₄)y.(K₂SO₄)z, where x+y+z=1 and x=0.43-0.64, y=0.15-0.43, and z=0.15-0.43.

Because of increased environmental restrictions and the limited availability of enriched oleum (i.e. >30%), hydrogen peroxide was concentrated to >70% using point of use vacuum evaporation of commercially available 50 or 70% technical grade hydrogen peroxide. This process is readily transferable for commercial production of the triple salts of the invention. By utilizing point of use concentrating of commercially available peroxide, transportation, handling & storage, and the high cost of >70% peroxide is all but eliminated. This practice allows for greater flexibility in preparation of the various composition, as well as use of oleum products of <30% for most compositions resulting from the disclosed invention.

An advantage of the invention is that it allows for direct front-end production of a Caro's acid solution substantially free of H²S²O⁸ for the production of a triple salt composition high in A.O. and substantially reduced K₂S₂O₈.

By producing a Caro's acid solution that is substantially free of H²S²O⁸, the tail-end reprocessing of the triple salt as disclosed in the prior art is no longer needed. Reprocessing of the triple salt slurry and/or discarding removed inert salts of the triple salt required to either dilute the K₂S₂O₈ &/or enrich the KHSO₅ concentrations of the final triple salt composition. Also, this inventions allows for the direct production of a non-hygroscopic triple salt that has a K/S ratio of greater than 1.10, resulting in a stable triple-salt with a melting point of greater than 90° C. without the need for further treatment to improve melting point or product stability. The increased A.O. with no H²S²O⁸ can be efficiently produced in the earliest stages of production in a direct once-through manner. The resulting neutralized Caro's acid solution provided from this invention can be directly processed to produce a triple salt product of high A.O. and substantially reduced K₂S₂O₈, thereby reducing waste of discarded salts, reducing equipment size to handle large recycles, energy from high recycle rates, and performing laborious chemical control checks and adjustments.

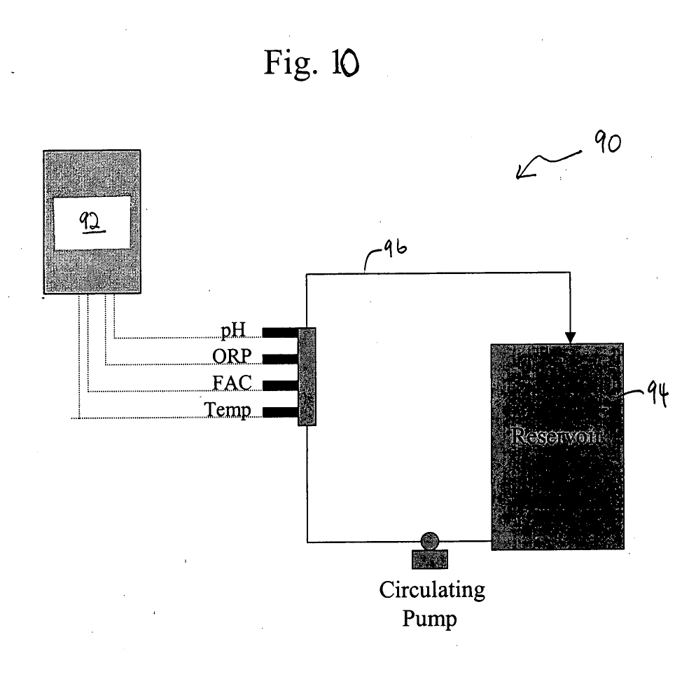

FIG. 10 is a schematic illustration of a monitoring system 90 for the reactor of the invention. As shown, a user interface unit 92 is coupled to probes that monitor various parameters in the reservoir 94 and the circulation path 96, if there is a circulation path in the system. The probes may detect the pH, the ORP, the FAC, and the temperature of the fluid in the reservoir 94 or the circulation path 96. The detected numbers are converted to some type of electrical signal and eventually presented to the user through the user interface unit 92. Methods of implementing the monitoring system 90 are well known.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. a single-stage reactor for producing a high-yield peroxyacid solution, the reactor comprising:
a reservoir for holding an oxyacid solution;
an inlet to the reservoir for receiving a peroxide solution, wherein the inlet is located such that a gradient of peroxide concentration forms in the oxyacid solution as a function of distance from the inlet upon addition of the peroxide solution and less than all of the oxyacid solution reacts with the peroxide solution at a given time; and
a heat exchange mechanism for maintaining the oxyacid solution at a temperature less than or equal to 20° C.

2. The reactor of claim 1, wherein the peroxyacid solution is a Caro's acid solution and the oxyacid solution is a sulfuric acid solution.

3. The reactor of claim 2, wherein the sulfuric acid solution is 93-100 wt. % H₂SO₄.

4. The reactor of claim 1, wherein the peroxide solution is at least 70 wt. % H₂O₂.

5. The reactor of claim 1, wherein the peroxide solution is a Caro's acid solution having a substoichiometric ratio of H₂SO₄:H₂O₂.

6. The reactor of claim 1, wherein the oxyacid is a Caro's acid solution.

7. The reactor of claim 1, wherein the reservoir is cylindrically-shaped, further comprising a stirring mechanism for radially circulating the oxyacid solution.

8. The reactor of claim 1, wherein the reactor is a batch reactor.

9. The reactor of claim 8 further comprising an outlet through which fluid exits the reservoir, wherein the outlet is positioned on an opposite end of the reservoir from the inlet.

10. The reactor of claim 1, wherein the reactor is a continuous multi-pass reactor comprising:
an outlet through which a fluid exits the reservoir;
a circulation path connecting the inlet to the outlet; and
a pump coupled to the outlet for directing the fluid exiting the inlet through the circulation path.

11. The reactor of claim 10 further comprising a set of input streams for adding reagents to the circulation path.

12. The reactor of claim 11, wherein one of the set of input streams is a stream of sulfuric acid solution.

13. The reactor of claim 11, wherein one of the set of input streams is a stream of peroxide solution.

14. The reactor of claim 13, wherein a rate of addition of the peroxide solution in the one of the set of input streams is controlled to maintain a substoichiometric molar ratio of H₂O₂ to H₂SO₄.

15. The reactor of claim 14 further comprising an output stream through which a fluid exits the circulation path, wherein the output stream is located between the outlet and the set of input streams.

16. The reactor of claim 15, wherein the fluid enters the reservoir through the inlet at a circulation rate, which is a flow rate at the outlet minus a flow rate of the output stream plus the flow rate of the input streams, and the circulation rate is selected to ensure a substoichiometric molar ratio of H₂O₂ to H₂SO₄.

17. The reactor of claim 11 further comprising a static mixer in the circulation path between the set of input streams and the inlet.

18. The reactor of claim 11 further comprising:
a detector for monitoring a yield of peroxyacid produced by a reaction between the oxyacid solution and the peroxide solution; and
a valve coupled to one of the set of input streams for stopping the addition of peroxide solution into the reservoir when the yield reaches a predetermined value.

19. The reactor of claim 10, wherein the reactor has a circular or elliptical cross section, further comprising a stirring mechanism for moving the oxyacid solution radially.

20. The reactor of claim 1, wherein the reactor is a continuous single-pass reactor and the reservoir has a first surface and a second surface coupled to each other by a sidewall and the inlet is a primary inlet, the reactor further comprising:
a secondary inlet for receiving the oxyacid solution into the reservoir, wherein the secondary inlet is located on a surface other than the surface on which the primary inlet is located,; and
an outlet located on the sidewall, between the primary inlet and the secondary inlet.

21-40. (Canceled)
